(19) United States
(12) Patent Application Publication
(10) Pub. No.: US 2012/0096391 A1
(43) Pub. Date: Apr. 19, 2012

(54) KNOWLEDGE BASE DATA GENERATION AND MANAGEMENT TO SUPPORT AUTOMATED E-HEALTH DIAGNOSIS SYSTEMS

(76) Inventor: William K. Smith, Washington, DC (US)

(21) Appl. No.: 13/276,293

(22) Filed: Oct. 18, 2011

Related U.S. Application Data
(60) Provisional application No. 61/394,015, filed on Oct. 18, 2010.

(51) Int. Cl. G06F 3/048

(52) U.S. Cl. 715/780

(57) ABSTRACT

Systems, methods and computer program products for the generation and management of knowledge base data to support automated e-health diagnosis systems are disclosed. Such systems, methods and computer program products provide the ability for a subject matter expert, without computer programming skills, to generate a knowledge base consisting of XML code that may be integrated into an automated e-health diagnosis system in order to provide real-time decision support. The subject matter expert may use the present invention, for example, to identify the symptoms that are relevant to a particular diagnosis, weigh symptoms relative to a given diagnosis, detail the rationale for particular decisions, and provide detailed treatment recommendations with regard to each individual diagnosis. The output of this tool may be an XML knowledge base that may be integrated, in a plug and play fashion, with the e-health diagnosis system.

### CROSS REFERENCE TO RELATED APPLICATIONS

This application claims priority to U.S. Provisional Application Ser. No. 61/394,015 (Atty. Docket No. MRL.01), filed on Oct. 18, 2010, which is hereby incorporated by reference in its entirety. This Application is also related to U.S. application Ser. No. 11/707,274 (Publ. No. 2007/0197882 A1), filed on Feb. 16, 2007, having common inventorship and hereby incorporated by reference in its entirety.

### FIELD OF THE INVENTION

The present invention generally relates to automated patient diagnosis system. Specifically, the present invention relates to systems, methods and computer program products for the management of data to support such automated patient diagnosis tools.

### BACKGROUND

It is common for people who are elderly, have disabilities, limited means or located in rural areas to have inadequate access to a doctor. Thus, in today's technological environment, information exchange, consultation, treatment, and even medical education via secure, quality electronic means has been a topic of discussions in hospitals, clinics, and private practices around the world. Today, there are healthcare professionals, lawmakers, and patients lobbying for better access to quality healthcare that can be provided locally or remotely. That is, electronic-based healthcare (“e-health”) is an integral part of today's medicine.

For example, integrated medical systems that allow the transmission of patient data via a network to a remote medical practitioner are known. Also known are methods and apparatus for analyzing data from remote monitoring equipment and determining whether an anomalous event has occurred, and whether the anomalous event warrants contacting a physician. Still further, systems and methods that are used for creating a medical record for an injured person having an interface for receiving information from a first responder or a health care practitioner via a plurality of mobile computing devices.

Recently, systems and methods that provide patients with viable diagnosis and treatment on the basis of symptoms and other information provided by the patient have been developed. Such systems and methods include receiving patient symptoms, comparing patient symptoms to previously-stored baseline symptoms, identifying the patient symptoms that correspond to the baseline symptoms, and providing one or more diagnoses that correspond to the identified patient symptoms.

Even given the foregoing, what are needed are systems, methods and computer program products for facilitating the ability of a subject matter expert, without computer programming skills, to generate and manage knowledge base data for such diagnosis systems to provide real-time decision support.

### SUMMARY

This summary is provided to introduce a selection of concepts. These concepts are further described below in the Detailed Description. This summary is not intended to identify key features or essential features of the claimed subject matter, nor is this summary intended as an aid in determining the scope of the claimed subject matter.

The present invention meets the above-identified needs by providing systems, methods and computer program products for facilitating the generation and management of knowledge base data to support automated e-health diagnosis systems.

In an embodiment, the present invention provides systems, methods and computer program products that facilitate the ability of a subject matter expert, without computer programming skills, may use to generate a knowledge base consisting of XML code that may be integrated into an automated e-health diagnosis system in order to provide real-time decision support. The subject matter expert may use the present invention, for example, to identify the symptoms that are relevant to a particular diagnosis, weigh symptoms relative to a given diagnosis, detail the rationale for particular decisions, and provide detailed treatment recommendations with regard to each individual diagnosis. The output of this tool may be an XML knowledge base that may be integrated, in a plug and play fashion, with the e-health diagnosis systems.

Further features and advantages of the present invention, as well as the structure and operation of various aspects of the present invention, are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements.

FIG. 1 is a block diagram of an automated e-health diagnosis system in which the present invention's tool for facilitating the generation and management of knowledge base data would operate according to an exemplary embodiment.

FIG. 2 is a flow chart illustrating a method for creating a database for diagnosis determination in which the present invention's tool for facilitating the generation and management of knowledge base data would operate according to an exemplary embodiment.

FIG. 3 is a flow chart illustrating a method for determining a diagnosis and treatment in which the present invention's tool for facilitating the generation and management of knowledge base data would support, according to an exemplary embodiment.

FIGS. 4A-C are screenshots illustrating exemplary graphical user interface (GUI) windows according to various embodiments of the present invention.

FIG. 5 is a block diagram (with data flow) of an exemplary system for facilitating the generation and management of knowledge base data to support automated e-health diagnosis systems, according to an aspect of the present invention.

FIG. 6 is a block diagram of an exemplary computer system useful for implementing the present invention.

FIG. 7 is an entity relationship diagram showing an exemplary database design according to an embodiment of the present invention.

### DETAILED DESCRIPTION

The present invention is directed to systems, methods and computer program products for facilitating the generation and management of knowledge base data to support automated e-health diagnosis systems.

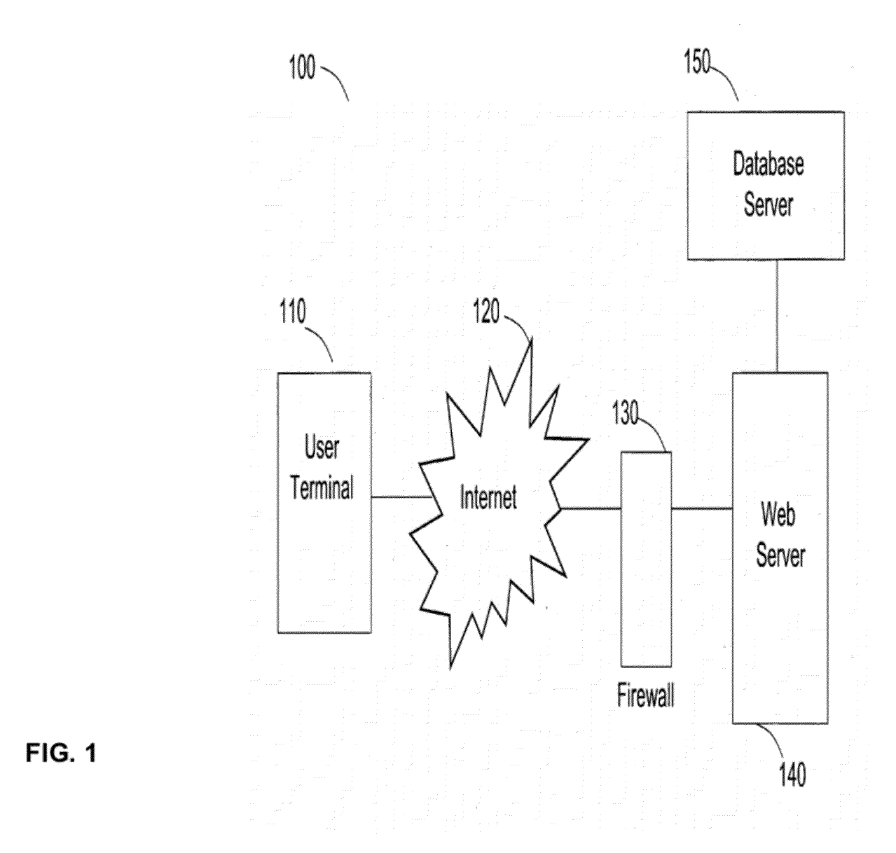

Referring to FIG. 1, a block diagram of an automated e-health diagnosis system 100 in which the present invention's tool for facilitating the generation and management of knowledge base data would operate, according to an exemplary embodiment, is shown.

System 100 includes a user terminal 110, operated by a user and connected to a server 140 such as a web server. Users may have varying levels of access to system functions and ability to interact, such as, for example, add and change data in the system or perform operations, depending on the user's access level. For example, a user access level may be added to security information upon access of the system, such as user name and password. According to various exemplary embodiments, the server 140 may be a remote server, and the user terminal 110 is connected to the server 140 via a network 120, such as the Internet. Also, the server 140 may be protected by a firewall 130, and may be connected to a data repository 150, such as a database server. In operation, a user may enter information into the user terminal 110. The information may be, for example, symptoms of an ailment or of an abnormal physical or mental condition. The information entered by the user may then be transmitted via the network 120 to the server 140. Once the information is received by the server 140, the information is used to determine a diagnosis, and possibly a treatment by matching information for similar symptoms stored in the data repository 150. According to various exemplary embodiments, the data repository 150 may contain a number of symptoms, and combinations of symptoms, and any corresponding diagnoses and treatments. The diagnoses and treatments of that correspond to the number of symptoms are determined on the basis of current medical knowledge and experience.

The data repository 150 database is a collection of records or information which is stored in a computer in a systematic or structured way, so that a user, via a computer program, for example, may consult it to answer queries. The computer program used to manage and query a database may be or include a database management system. The records retrieved in response to queries become information that can be used to make diagnosis and treatment decisions. The database may be queried via a series of computer screens prompting the user, whether a patient or health care practitioner, to enter the symptoms suffered by the patient. According to various exemplary embodiments, the various computer screens vary from providing very broad queries to more specific ones on the basis of the responses entered for the broad queries.

In U.S. Patent Application Publ. No. 2007/0197882 A1 (the ”'882 Publication“), having common inventorship with the present application, an exemplary e-health diagnosis system is disclosed. The system for determining a diagnosis and treatment includes the ability to receive patient symptoms, compare patient symptoms to previously stored baseline symptoms, identify the patient symptoms that correspond to the baseline symptoms, and provide diagnoses that correspond to the identified patient symptoms to a user.

The system and method disclosed in the '882 Publication integrates clinical decision support into the medical charting process in a flexible, scalable and comprehensive manner. For example, the system disclosed in the '882 Publication is capable of producing various diagnosis display screens as recommendations to a health provider, as well as showing a list of the clinical decisions made by the provider. The differential diagnosis list may be based on patient data processed through decision support modules. Each recommendation may include a likelihood generated by the system, which provides a level of confidence associated with the recommendation. In an embodiment, there are four possible likelihoods displayed in decreasing order of confidence in the exemplary screen: (1) “Consider,” which means that the signs and symptoms are consistent with the diagnosis; (2) “Rule Out,” which means that the signs and symptoms are consistent with the diagnosis and sufficiently relevant that the system recommends further investigation or diagnostic testing associated with the diagnosis; (3) “Probable,” which means that the signs and symptoms and/or diagnostic results are highly relevant to the diagnosis; and (4) “Confirm,” which means that the signs and symptoms and/or diagnostic results are highly relevant to the diagnosis, and laboratory results are sufficient to provide high confidence. System Recommendations may be recorded in a patient's medical record. A diagnosis may only be recorded when the provider makes a clinical diagnosis by setting the final status of a recommendation.

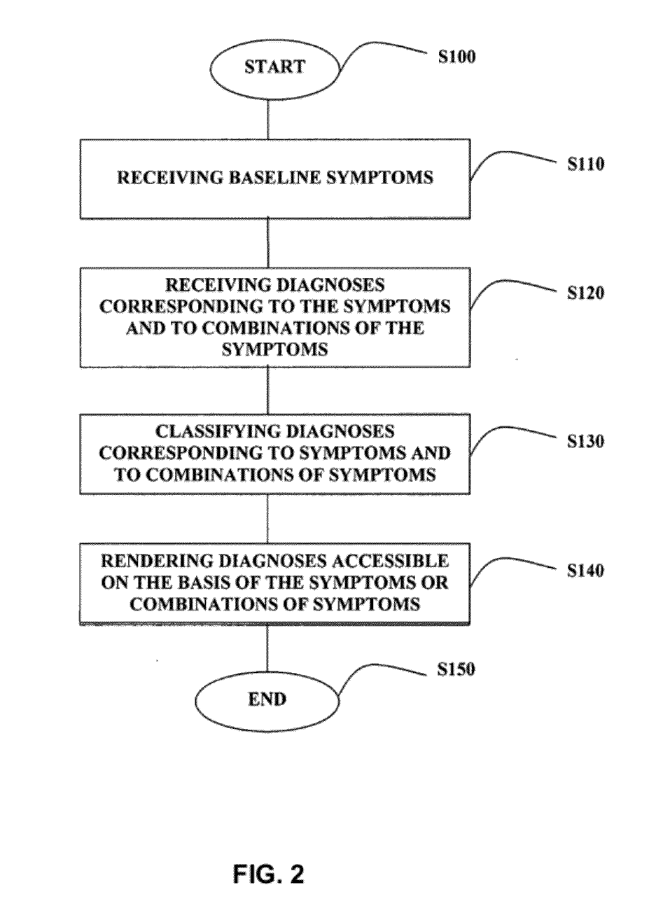

Referring to FIG. 2, a flow chart illustrating a method for creating a database for diagnosis determination in which the present invention's tool for facilitating the generation and management of knowledge base data would operate, according to an exemplary embodiment, is shown. The method starts in step S100 and continues to step S110, where baseline symptoms are received. For example, baselines symptoms may be any symptoms currently known to have occurred on people or animals, and that are symptomatic of an abnormal physical or mental condition. Baseline symptoms may be a headache, chest pain, bleeding, loss of consciousness, temporary loss of vision, and the like. When received, the baseline symptoms may be stored in memory.

Next, the method continues to step S120, where the various diagnoses corresponding to the received symptoms are also received and stored in memory. For example, a diagnosis of “stroke” may be entered as corresponding to the baseline symptom “loss of consciousness.” Also, a plurality of diagnoses may be received that correspond to the same baseline symptom. For example, not only a diagnosis of “stroke” may be received as corresponding to the baseline symptom “loss of consciousness,” but also a diagnosis of “heat exhaustion” or “emotional trauma” can be received that corresponds to the same baseline symptom of “loss of consciousness.”

Furthermore, other diagnoses may be received that correspond to not only one baseline symptom, but to a combination of baseline symptoms. For example, the diagnosis “stroke” may be received as corresponding to the combination of “loss of consciousness” and “loss of the ability to speak.” Accordingly, the combination of the two baseline symptoms “loss of consciousness” and “loss of the ability to speak” effectively results (i.e., through a decision tree function in the software) in the elimination of the diagnoses “heat exhaustion” and “emotional trauma” because the combination of the two baseline symptoms is more likely to correspond to the diagnosis “stroke” than to any one of the other two possible diagnoses. Thus, another class of diagnoses can be received that corresponds to a combination of baseline symptoms, such that a smaller number of possible diagnoses is received because these diagnoses correspond to a combination of baseline symptoms.

Ultimately, if a large enough number of baseline symptoms are combined, only one corresponding diagnosis may be associated with this combination and stored in memory. Furthermore, the diagnoses may be regularly updated on the basis of the latest medical progress. Next, the method continues to step S130, where the various received diagnoses are classified in terms of the baseline symptoms to which they correspond, and in terms of any combinations of baseline symptoms to which they correspond. For example, the diagnosis “stroke” can be classified as being a possible diagnosis for each baseline symptom “loss of consciousness,” “garbled language,” and “loss of vision,” and also for being a possible diagnosis for any combinations of these three baseline symptoms.

Next, the method continues to step S140, where the diagnoses are rendered accessible on the basis of the baseline symptoms. In other words, an interface may be made available to a user to allow the user to associate the different diagnoses and their corresponding symptoms or combinations of symptoms for access for diagnosis and treatment purposes based on symptoms and other information. Next, the method continues to step S150, where the method ends.

It should be noted that various symptoms may be assigned different weight in the determination of a final diagnosis. For example, the symptom of “loss of the ability to speak” may be assigned a greater weight than the symptom of “loss of consciousness” in the determination of the diagnosis of a “stroke.” Furthermore, other symptoms may be assigned a different weight because, for example, they may eliminate a given diagnosis. For example, the symptom “belly ache” may be weighted negatively in relation to the diagnosis “stroke.” In other words, if the symptom “belly ache” is received, then the diagnosis “stroke” may be eliminated from the list of possible diagnoses.

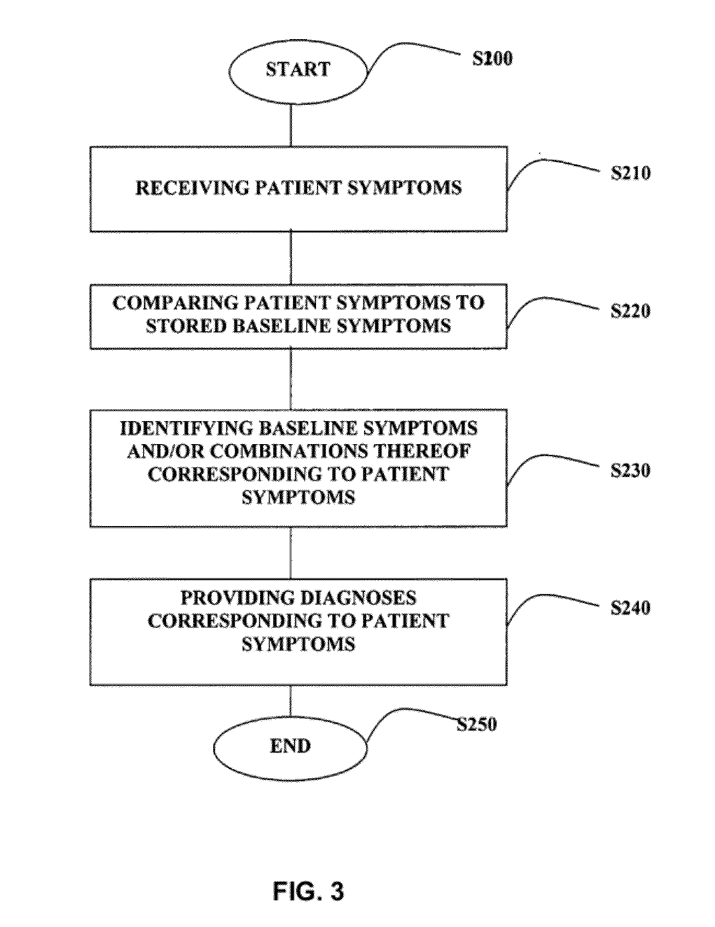

Referring to FIG. 3, a flow chart illustrating a method for determining a diagnosis and treatment in which the present invention's tool for facilitating the generation and management of knowledge base data would support, according to an exemplary embodiment, is shown. The method starts in step S200 and continues to step S210, where patient symptoms are received. For example, patient symptoms may be any symptoms currently known to have occurred on a patient, and that are symptomatic of an abnormal physical or mental condition of the patient. Patient symptoms may be a headache, chest pain, bleeding, loss of consciousness, temporary loss of vision, and the like. Next, the method continues to step S220, where the received patient symptoms are compared to the stored baseline symptoms. According to an exemplary embodiment, the patient symptoms are compared to every single baseline symptom stored in memory, and in the case of a combination of patient symptoms, that combination is compared to every combination of baseline symptoms stored in memory.

Next, control continues to step S230, where all the baseline symptoms that correspond to the patient symptoms are identified. According to an exemplary embodiment, in the case where a combination of patient symptoms is received, then either all or a part of the patient symptoms of that combination are identified to one or more combinations of baseline symptoms on the basis of a similarity between patient symptoms and baseline symptoms. Next, the method continues to step S240, where the diagnoses that correspond to any identified baseline symptom, or to any identified combination of baseline symptoms, as corresponding to the patient symptoms, are provided to a user. For example, the diagnoses may be displayed on a computer screen, or printed out on an imaging medium. Next, the method continues to step S250, where the method ends.

Further, an automated e-health diagnosis system such as the system disclosed in the '882 Publication can be implemented using hardware, software or a combination thereof and may be implemented in one or more computer systems or other processing systems. In one embodiment, it may be implemented using a Dream Weaver interface and Visual Basic programming via three major elements: in three components: a server (personal medical record) application, an authorware element, and a client (clinical encounter) application (collectively referred to herein as, the “Toolbox”) in order to achieve a proper diagnosis determination on the basis of a patient's symptoms. According to various exemplary embodiments, a fourth element, a Command and Control Interface, may be added.

The server-side personal medical record element may be the portion where a patient may use the application to manage information pertaining to his/her clinical or medical history. Thus, the patient may create a personal medical record (PMR). Data from this application may be stored in a secured way that is readily accessible to the patient or to a health care operator. The degree to which the application can be accessed by the health care operator may also be set, for example, by the patient.

The authorware element may be an element that a subject matter expert, without computer programming skills, may use to generate a knowledge base consisting of XML code that may be integrated into the client-side clinical encounter application in order to provide real-time decision support. The subject matter expert may use this tool to, for example, identify the symptoms that are relevant to a particular diagnosis, weigh symptoms relative to a given diagnosis, detail the rationale for particular decisions, and provide detailed treatment recommendations with regard to each individual diagnosis. The output of this application may be an XML knowledge base that may be integrated, in a plug and play fashion, with the client-side clinical encounter application.

The client-side clinical encounter application may integrate data from the PMR and input from the clinician during the clinical encounter with the decision support knowledge base generated by the subject matter experts using the authorware element. That is, the client-side clinical encounter application functionally couples the data from both the PMR and the authorware to achieve the result of providing treatment recommendations, and may be implemented by a health care operator such as, for example, a clinician. The result is real-time recommendations regarding diagnosis and treatment as well as readily available explanations regarding the rationale for such recommendations. Additional features may include a plug-and-play integration of knowledge bases, the integration of data from the PMR and the ability of individual client-side clinical encounter applications to synchronize their information with a network-based command and control interface, such as a web-based command and control interface. Additionally, another party such as, for example, a manager, may oversee the operation of the entire system that includes the above-described elements and, for example, obtain situational awareness, direct resources to specific areas or take action based on real-time data. Such a system may also be used in the context, for example, of a network of health care providers.

The Toolbox components can be jointly used, for example, to facilitate clinical data capture and exchange for traumatic brain injuries at a hospital. Central to the system, however, is the authorware that guides (expert) users through the creation of knowledge bases and automatically generates “plug-and-play” modules that provide decision support in the context of electronic data capture.

In an embodiment of the present invention, the functionality of the authorware, and its integration with an electronic data capture tool to produce clinical decision support at the point of care, allows users to author decision support. The system's knowledge bases, in one aspect, include the following topics: Cardiac, Dermatology, Diabetes, Infectious Diseases, Ear/Nose/Throat, Endocrine, Environmental, Fluids/Electrolytes, Gastrointestinal, Genitourinary, Gynecology, Immunization, Male Reproductive, Mental, Neurology, Obstetrics, Orthopedic, Podiatry, Respiratory, Toxicology, and Trauma.

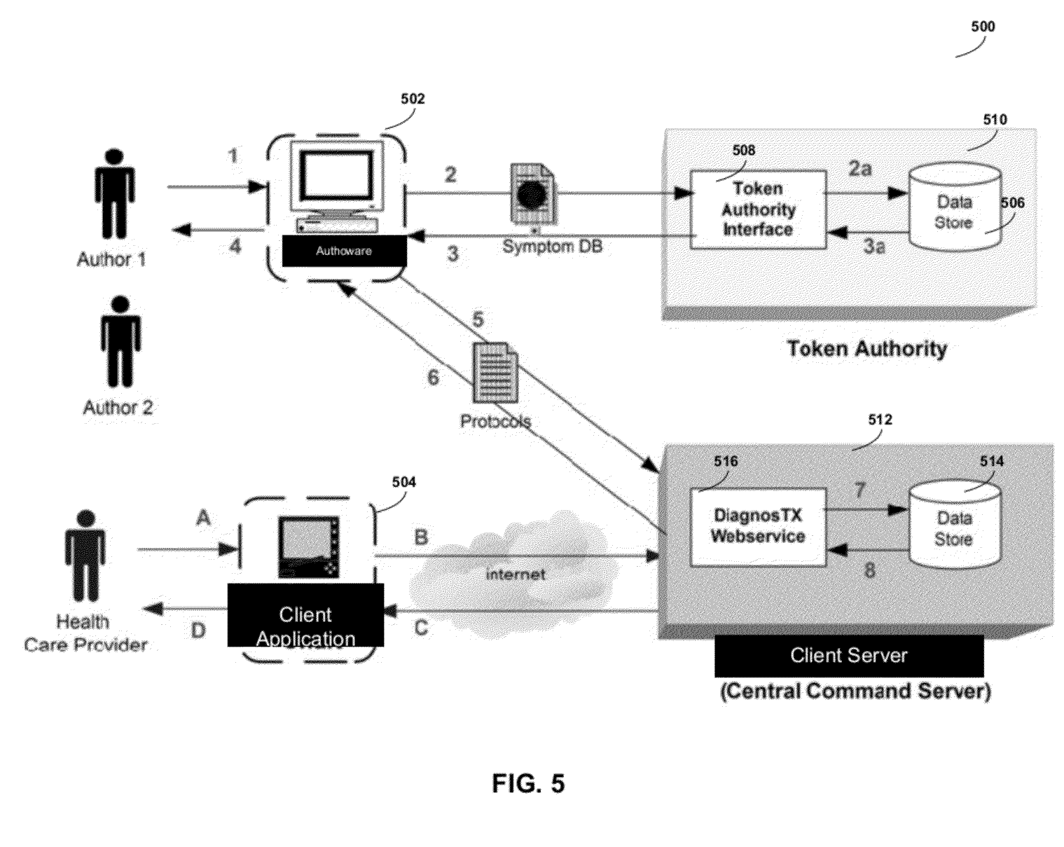

Referring to FIG. 5, a block diagram (with data flow) of an exemplary system 500 for facilitating the generation and management of knowledge base data to support automated e-health diagnosis systems, according to an aspect of the present invention, is shown

System 500 includes one or more subject matter expert authors, with or without computer programming skills, who will generate and manage knowledge base data for a diagnosis system (e.g., system 100) to provide real-time decision support to one or more health care providers (e.g., a doctor in the battlefield, a first responder, etc.). The authors would utilize an authorware application 502 having a GUI API 508, via a desktop computer or may be another computing device such as, for example, a laptop or notebook computer, a personal digital assistant (PDA), a tablet, a palmtop, or a mobile computer, a mobile telephone, any commercially-available intelligent communications device 110, or the like. The subject matter expert may use authorware application 502 to identify the symptoms that are relevant to a particular diagnosis, weigh symptoms relative to a given diagnosis, detail the rationale for particular decisions, and provide detailed treatment recommendations with regard to each individual diagnosis. The output of this application may be an XML knowledge base that may be integrated, in a plug and play fashion, with a client-side clinical encounter application 504.

Any newly-created symptom data may be uploaded (assuming author authorization) to a central data store 506 within a Token Authority 510. Authorware application 502 also allows protocols to be downloaded to a central command server 512 having a local data store 512 and executing a client-side application 516 which serves e-health diagnosis application web pages to a healthcare provider in the field using, for example, a laptop or notebook computer, a PDA, a tablet, a palmtop, a mobile computer, a mobile telephone, or any commercially-available intelligent communications device 504 via, for example, the Internet.

The present invention allows an automated e-health diagnosis system data elements (e.g., the Toolbox of the system disclosed in the '882 Publication), which may be contained in protocol files and patient encounter records, to be mapped across various system deployments and versions. The specifications of the present invention also facilitates the mapping of the unique tokens generated by the Toolbox to one or more standardized medical terminology solutions such as SNOMED CT® (Systematized Nomenclature of Medicine—Clinical Terms), LOINC® (Logical Observation Identifiers Names and Codes), ICD-9 (International Statistical Classification of Diseases and Related Health Problems), the National Library of Medicine's RxNorm or the like. To accomplish these goals, the present invention takes a technical approach based on the current architecture of authorware application 502 and client-side applications 516 of the Toolbox.

In an embodiment, natural language terminology is entered by the expert author and assigned a unique identifying number (i.e., a token) by authorware element 502. In addition to receiving a unique token, prior to deployment, every element is tagged as being one of:
sign/symptom
major container (Physical Exam, History, Allergies, etc.)
body system
lab result
other element of the sign/symptom tree structure
protocol name
intervention name
form name
question within a form
answer to a question within a form

In an embodiment, the present invention specifies the technological components of a system for rationalizing the assignment of tokens in a comprehensive and uniform manner so as to facilitate data analysis and exchange within an automated e-health diagnosis system. The approach centers on:

1. Allowing users to more readily utilize natural language prompts to draw upon an embedded common data dictionary in the creation and coding of elements for use in individual data collection efforts.

2. Facilitating the mapping of common dictionary elements to standardized terminology solutions such as SNOMED CT, LOINC, Rx Norm and the like.

3. Creating server software to facilitate the operation of a central token authority 510 serving as an intermediary between system users in the creation and maintenance of a common data dictionary.

4. Permitting communication with the token authority 510 so as to facilitate the validation and coding by the token authority 510 of terms not contained in the locally-deployed data dictionary 514.

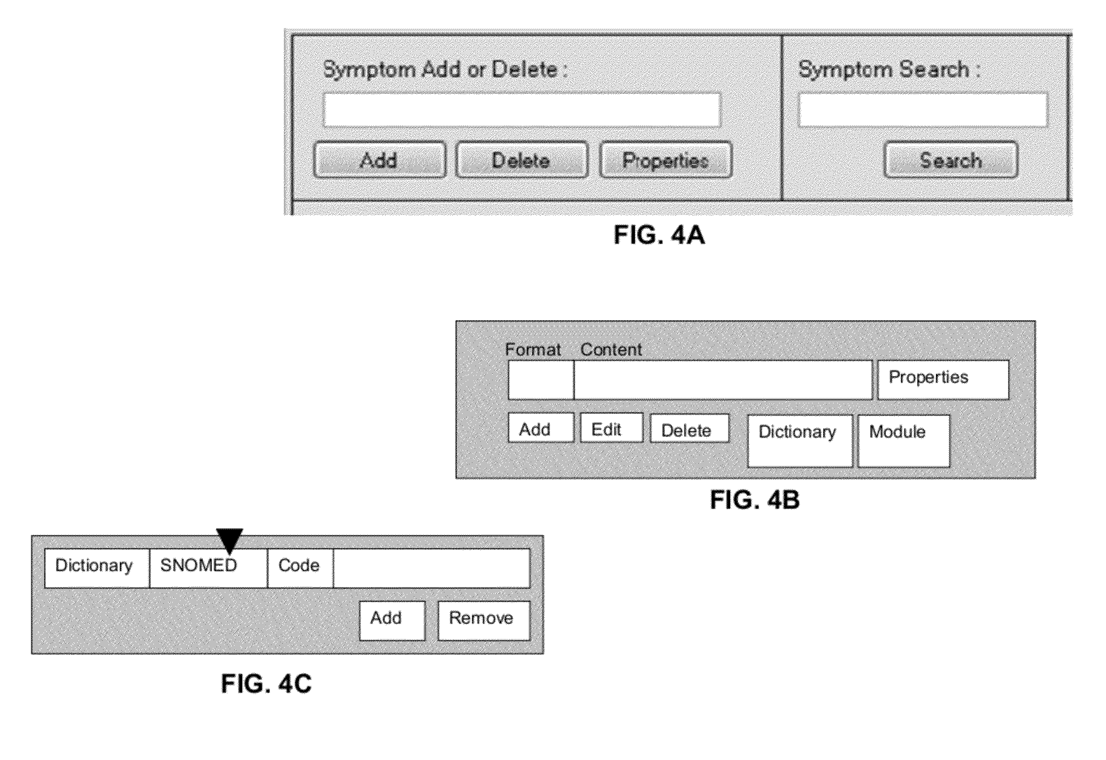

In an automated e-health diagnosis system (e.g., the system disclosed in the '882 Publication), a screen display that facilitates the ability of a subject matter expert to add and delete symptom database entries, setting their properties, and searching the database within an automated e-health diagnosis system is shown in the FIG. 4A.

The present invention, however, allows a subject matter expert users to more readily utilize natural language prompts to draw upon an embedded common data dictionary in the creation and coding of elements for use in individual data collection efforts. Such an input screen is shown in FIG. 4B. Natural language entries may have one or two components, an optional format component and a mandatory content component. For example, the entry “10. Head Injury” has a format component “10.” and a content component “Head Injury”. Entries in the content component box are drawn from the embedded dictionary with the associated tokens. The format component shall not have an associated dictionary token. Similar entries such as “17. Head Injury” and “Head Injury” might appear elsewhere within the symptom database hierarchy. In all cases, the dictionary token for “Head Injury” shall be the same. Both the format component and the content component are be used in the system interface for display and reporting purposes.

In an embodiment, when either format or content components are being entered, authorware application 502 provides an auto complete function allowing the user to review existing embedded data dictionary items that begin with the entered string.

The Dictionary Search button shown in FIG. 4B displays a pop-up menu that provides a listing of all dictionary entries that contain any of the key words entered in the “content” window. The user may select one of the displayed dictionary entries and then select “Add.” The authorware element then displays the selection in the “Content” window.

Whenever the “Add” button is selected in an attempt to add content that is not included in the embedded dictionary, the authorware element shall display a pop-up stating “This entry is not included in the authorized dictionary. Do you wish to request this addition?” If the user chooses to request an addition, the authorware shall add the entry to the local dictionary and tag it as unauthorized. This allows the user to complete protocols in work with unauthorized dictionary entries. However, unauthorized dictionary entries must be authorized before associated protocols or forms can be deployed to the client-side or server-side applications.

As the user is navigating the hierarchical structure of the symptom database, the format and content components of the selected entry shall be displayed as shown in FIG. 4B. The user may choose to modify either component by selecting “Edit” and then selecting “Add.”

The “Module” search button performs the same function as the “Search” button (i.e., a pop-up menu) but provides a hierarchical listing of all symptom database entries that include the entered item.

In an embodiment of the present invention, a display screen shown in FIG. 4C is enabled whenever the user selects an entry within the embedded data dictionary. This will allow the user to view, or enter coding, for standardized terminology solutions such as SNOMED CT, LOINC, RxNorm, or the like, in connection with that particular term. The user shall have the option to associate the selected item with a standardized terminology code by first selecting the standardized terminology from the dropdown, and selecting “Add.” The user shall have the option of entering multiple tokens for any particular standard dictionary.

In an embodiment, the authorware assigns a unique, unauthorized token to each term that is not currently in the local embedded database. The Token Authority 510 must authorize the unauthorized token assigned by authorware before the element may be deployed by the client/server applications. The authorized token and not the standardized nomenclature (e.g., SNOMED CT) code shall be used to uniquely identify elements within the Toolbox. Dictionary tokens are never changed or edited, only replaced and mapped so the integrity of old data will not be compromised. Token Authority 510 maintains a list of all the tokens that have ever been deployed, and their associated mapping. This facilitates the transfer and exchange of existing data sets. Every entry in the system may not map directly to an existing standardized terminology code. However, the author may identify a new code that defines the association (as SNOMED CT currently allows).

In an alternate embodiment, the authorware shall not require a standardized terminology code. Rather, the authorware allows editing of standardized codes that were previously entered. Different entries in the authorware database may have the same standardized code. The authorware may allow more than one code to be entered for a given standard.

In an embodiment, Token Authority 510 manages the master data dictionary on the server application. This includes natural language terms with the corresponding tokens, as well as any associated standardized terminology codes. An easily readable rendering of this dictionary, including the terms, tokens, and codes shall be displayed on the server. Upon entry of a natural language term into the authorware that is not contained in the locally-embedded data dictionary 514, the authorware application shall flag the term as “unapproved” and attempt to initiate a connection to Token Authority 510 server in order to validate the term and receive a token assignment. When the connection is made, the server shall assign a token to unapproved dictionary entries and automatically reset the unapproved tag to “approved.” All unapproved flags shall be removed and the locally-embedded dictionary 514 updated before modules using the subject term may be deployed on the local client server. The authorware may have a manual override capability for the local deployment of unapproved data elements facilitating such deployment to a local server.

In an embodiment, Token Authority 510 and authorware may allow users to download the authorized common dictionary and from the server application. During the download sequence, the authorware shall flag any common dictionary entries that are not currently available in the locally-embedded dictionary 514, display those new entries and either update the entire local dictionary or terminate the process at the discretion of the user.

The exemplary following use cases are included herein for clarification:
I. Author creates new dictionary item.
II. Author edit newly created dictionary item (Token not assigned).
III. Author edit dictionary item (Token assigned).
IV. Author uploads dictionary to Token Authority.
V. Author edits dictionary item (Token assigned) and new text already present in dictionary of Token Authority.
VI. Author downloads dictionary from Token Authority.
VII. Author uploads symptom database to Toolbox Server
VIII. Author exports symptom database locally.

I.

| | |
|---|---|
| Description | Author creates new dictionary item. |
| Actors | authorware Author |
| | Token Authority Server |
| Pre-conditions | |
| Main Flow | 1. Author creates new dictionary item |
| | 2. New dictionary item will be added locally |
| | without token. |
| | 3. Assign SNOMED CODE [Optional]. |
| | 4. Author selects “Upload to Token Authority” |
| | 5. Symptom DB (item.xml) gets uploaded to |
| | Token Authority Server [Use case IV]. |
| Alternate Flow | |

II.

| | |
|---|---|
| Description | Author edits newly created local dictionary item |
| | (to which Token is not assigned). |
| Actors | authorware Author. |
| | Token Authority Server |
| Pre-conditions | |
| Main Flow | 1. Author selects item. |
| | 2. Author edits selected newly added dictionary item. |
| | 3. Author selects “Upload to Token Authority” |
| | 4. Symptom DB (item.xml) gets uploaded to Token |
| | Authority Server [Use case IV]. |
| | Note: User can edit complete text without any |
| | restriction if item is still local (i. e., token is |
| | not assigned to item by Token Authority). |
| Alternate Flow | |

III.

| | |
|---|---|
| Description | Author edits dictionary item (Token assigned). |
| Actors | Authorware Author. |
| Pre-conditions | |
| Main Flow | 1. Author selects item. |
| | 2. Author edits selected dictionary item. |
| | 3. Item will be flagged as ‘edited locally’. |
| | 4. Author selects “Upload to Token Authority” |
| | 5. A Symptom DB (item.xml) gets uploaded Token |
| | Authority [Use case IV]. |
| Alternate Flow | 1.1A Author changed SNOMED CODE and not the |
| I | item text. |
| | 1.2B SNOMED CODE will get changed for dictionary |
| | item. |
| | 1.3C Item will get flagged as SNOMED CODE edited. |
| | Note: The older SNOMED CODE will not get deleted |
| | from dictionary it will be union of previous and |
| | currently assigned CODE. |
| Alternate Flow | 2.1A Author changes verbiage in item text. |
| II | 2.2B authorware flags error ‘Token assigned to item, |
| | only minor change is allowed e.g., white space, special |
| | characters (comma, semicolon, etc.)’. |

IV.

| | |
|---|---|
| Description | Author uploads dictionary to Token Authority. |
| Actors | authorware Author. |
| | Token Authority. |
| Pre-conditions | |
| Main Flow | 1. Author uploads dictionary to token authority. |
| | 2. Token authority generates token for newly added |
| | items. |
| | 3. Token authority logs the item text of dictionary |
| | item with date of creation and details like IP address, |
| | machine name etc. |
| | 4. Token authority edit dictionary for edited item. |
| | 5. Token authority logs the older text of dictionary |
| | item with date of modification and author details like |
| | IP address, machine name etc. |
| | 6. Token authority modifies the SNOMED, ICD |
| | CODE for token. |
| | 7. Token authority sends latest dictionary to author's |
| | authorware. |
| | 8. authorware updates/process local symptom database |
| | and protocol files with latest dictionary tokens. |
| | 9. authorware flags database as approved. |
| Alternate Flow | 4.1A Author edits dictionary item (Token assigned) |
| | and new text already present in dictionary of Token |
| | Authority [Use Case V]. |

V.

| | |
|---|---|
| Description | Author edits dictionary item (Token assigned) and new |
| | text already present in dictionary of Token Authority. |
| Actors | Token Authority |
| Pre-conditions | |
| Main Flow | 1. Token Authority retires the older token. |
| | 2. Token authority maps the older token with new token |
| | for historic purpose. |
| | 3. Token authority logs the item text of dictionary item |
| | with date of creation and author details like IP address, |
| | machine name etc. |
| | Note: This is the rare scenario where author 1 corrects |
| | the minor text (space, special character etc) in item 1 |
| | (token 1) and author 2 adds and uploaded the same |
| | item with which has been corrected by author 1. |
| | e.g., Author A1 modifies Item i1 is ‘other specify’ |
| | with token t1 to ‘other, specify’ minor correction |
| | (comma added) |
| | Meanwhile, before Author A1 uploads dictionary to |
| | Token authority. Author A2 added item i2 ‘other, |
| | specify’ and uploaded to Token authority which got |
| | token t2. |
| | Token authority will get confused when corrected text |
| | already exist against different token. |
| Alternate Flow | |

VI.

| | |
|---|---|
| Description | Author downloads dictionary from Token Authority. |
| Actors | authorware Author. |
| | Token Authority. |
| Pre-conditions | |
| Main Flow | 1. Author downloads dictionary from token authority |
| | [New Installation]. |
| | 2. authorware downloads and save dictionary. |
| Alternate Flow | 1.1A Dictionary already present locally in authorware. |
| | 1.2B authorware downloads and save dictionary. |
| | 1.3C authorware updates/process local symptom |
| | database and protocol files with latest dictionary tokens. |
| | 1.4 D authorware flags database as approved. |

VII.

| | |
|---|---|
| Description | Author uploads symptom database to Toolbox Server. |
| Actors | authorware Author. |
| | Toolbox Server. |
| Pre-conditions | |
| Main Flow | 1. Author uploads symptom database to Toolbox |
| | Server. |
| | 2. Toolbox Server validates for approved symptom |
| | data. |
| | 3. Toolbox Server saves symptom data. |
| | [Approved is the one that is from token Authority and |
| | not locally modified by author] |
| Alternate Flow | 2.1A Toolbox Server identify for unapproved |
| | symptom data. |
| | 2.2B Toolbox server notifies authorware about |
| | unapproved symptom database. |

VIII.

| | |
|---|---|
| Description | Author exports symptom database locally. |
| Actors | Authorware Author. |
| Pre-conditions | |
| Main Flow | 1. Author exports symptom database locally. |
| | 2. Authorware marks symptom database as |
| | approved if dictionary is up to date with respect |
| | to Token Authority otherwise marked as |
| | unapproved if any items are not approved with |
| | Token Authority or edited locally. |
| Alternate Flow | |

In an embodiment, the data dictionary terminology and database structure used within authorware application 502 having GUI API 508 to ensure common understanding of the natural language input by the subject matter expert authors would be as follows.

In an embodiment, data store 506 would contain a “nls_type” (natural language string type) table containing user defined natural language string values (i.e., those entered in the “Content” field as shown in FIG. 4B, and having the structure:

| Field Name | Data Type | Description |
|---|---|---|
| Id | Integer | It will be the primary key of the table. |
| Name | varchar(50) | Description of the NLS type. |

Where the table is pre-populated with the data:

| id | Name |
|---|---|
| 1 | Form |
| 2 | Question |
| 3 | Answer |
| 4 | Treatment |
| 5 | Diagnostic Test |
| 6 | Education |
| 7 | Follow up |
| 8 | Outcomes |
| 9 | Others |

In an embodiment, data store 506 would contain a “natural language string” table that contains the natural language string entered from authorware application 502 and contains the unique NLS_Id and the NLS_type for the natural language string. The NLS_Id is a unique identifier (integer value) generated for each unique natural language string entered as “Content” using authorware 502. The NLS_Type distinguishes various types of natural language strings that can be entered. For example “Oral Antibiotic” can be entered as a Treatment and “Oral Antibiotic” can also be an Answer (in a form). So “Treatment”, and “Answer” are a type of token. The table has the structure:

| Field Name | Data Type | Description |
|---|---|---|
| nls_id | Integer | This will be unique token id |
| | | for the unique content string |
| | | entered |
| natural_language_string | nvarchar(max) | This will contain the natural |
| | | language string |

In an embodiment, data store 506 would contain a “composite token” which is a combination of NLS_type and the natural language string's unique ID. The table has the structure:

| Field Name | Data Type | Description |
|---|---|---|
| Composite | Integer | This will be the Primary Key and will |
| token_id | | represent the composite token id |
| nls_id | Integer | Id of a natural language string. Foreign |
| | | Key to natural_language_string table |
| nls_type_id | integer | Id of a NLS type. This is a foreign key |
| | | to nls_type table |

In an embodiment, data store 506 would contain a “codification_system” table containing the leading codification systems such as SNOMED, ICD, etc. and has the structure:

| Field Name | Data Type | Description |
|---|---|---|
| Id | Integer | It will be the primary key of the table |
| Name | varchar(50) | Name of coding system |

In an embodiment, data store 506 would contain a “clinical_data_code” table containing the clinical codes assigned to clinical data elements in the coding systems available in the codification_system table. This table will maintain the uniqueness of the clinical code within a codification system and has the structure:

| Field Name | Data Type | Description |
|---|---|---|
| Id | Integer | It will be the primary |
| | | key of the table |
| Codification_system_id | Integer | Foreign Key; ID of a |
| | | codification system |
| Value | Varchar(100) | Clinical data code value |

In an embodiment, data store 506 would contain a “composite_token_clinical_code_relation” table containing mapping of clinical codes with the composite token (natural_language_string+nls_type). Each composite token can have multiple clinical codes associated with it and each clinical code can be assigned to multiple composite tokens, so this table maintains the mapping. It has the structure:

| Field Name | Data Type | Description |
|---|---|---|
| Sys_Id | Integer | Primary key. Auto increment. |
| Composite_token_id | Integer | Id of a token. Foreign key to |
| | | composite_token table. |
| Clinical_data_code_id | Integer | This is foreign key of |
| | | clinical_data_code table. |

In an embodiment, data store 506 would contain an “activity_log” table containing data dictionary activities. That is, it stores natural language strings as they are created. It has the structure:

| Field Name | Data Type | Description |
|---|---|---|
| Sys_Id | Integer | Primary Key. This will be |
| | | auto generated. |
| Composite_token_id | Integer | This will represent the |
| | | composite token id inserted. |
| nls | nvarchar(Max) | The natural language string. |
| Operation | Varchar(100) | Details about the activity. |
| Machine_name | Varchar(100) | Name of the user's machine |
| | | which created the log. |
| Machine_IP | Varchar(100) | IP address of the user's machine. |
| Mac_id | Varchar(100) | Mac Id of the user's machine. |

In alternate embodiments of the present invention, one or more of the following rules may be enforced when an author uses authorware 502:
1. When similar natural language strings are entered for different types, the same NLS_id will be assigned, but separate composite_token_id will be assigned. Thus, if “Headache” is entered as a Question and an Answer, it will have the same NLS_id and be stored only once in an output xml file with the corresponding NLS_id. If “Headache” is entered again as any other type, it will be assigned the same NLS_id as before, there will be no new entry to the output xml file.
2. Comparison of natural language strings will be case sensitive. Thus, “NAME” and “Name” will get separate NLS_id's and there will be two separate entries in the output xml file.
3. If a natural language string already has an NLS_id and is being modified, the modified string will be treated as a separate string and will get a new NLS_id. (But, if a natural language string already has NLS_id, and only a minor change is made, no new NLS_id will be issued.)

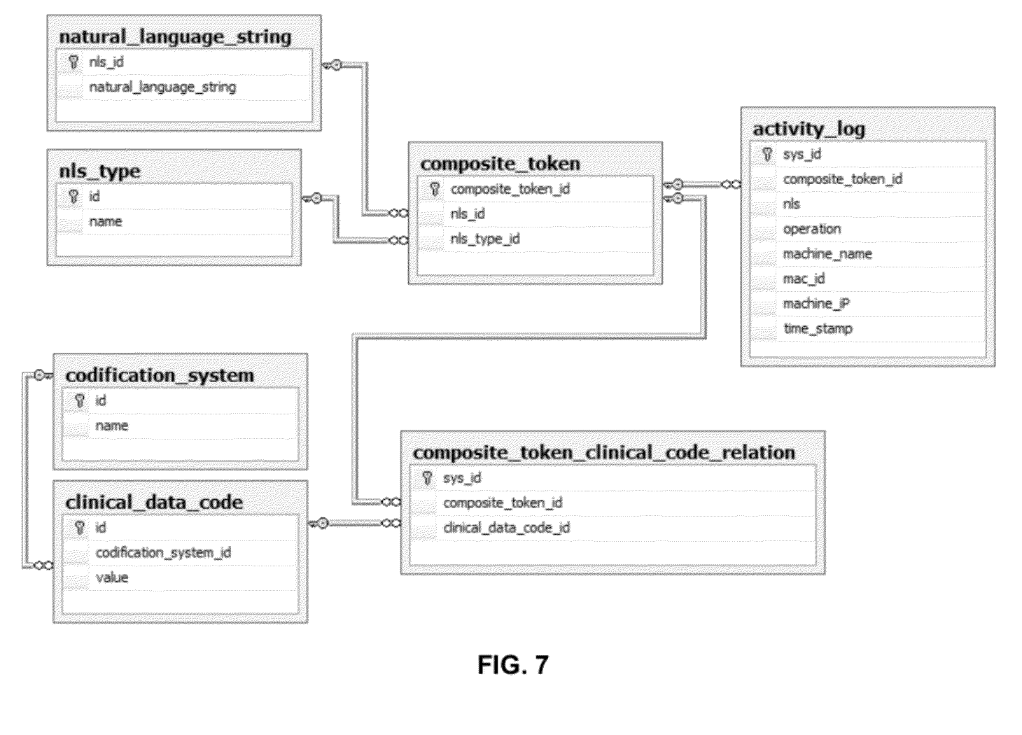

Referring to FIG. 7, an entity relationship diagram showing an exemplary database design, according to an embodiment of the present invention, is shown. That is, FIG. 7 illustrates the relationship between the tables listed above according to an embodiment of the present invention.

The present invention (or any part(s) or function(s) thereof) may be implemented using hardware, software or a combination thereof and may be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

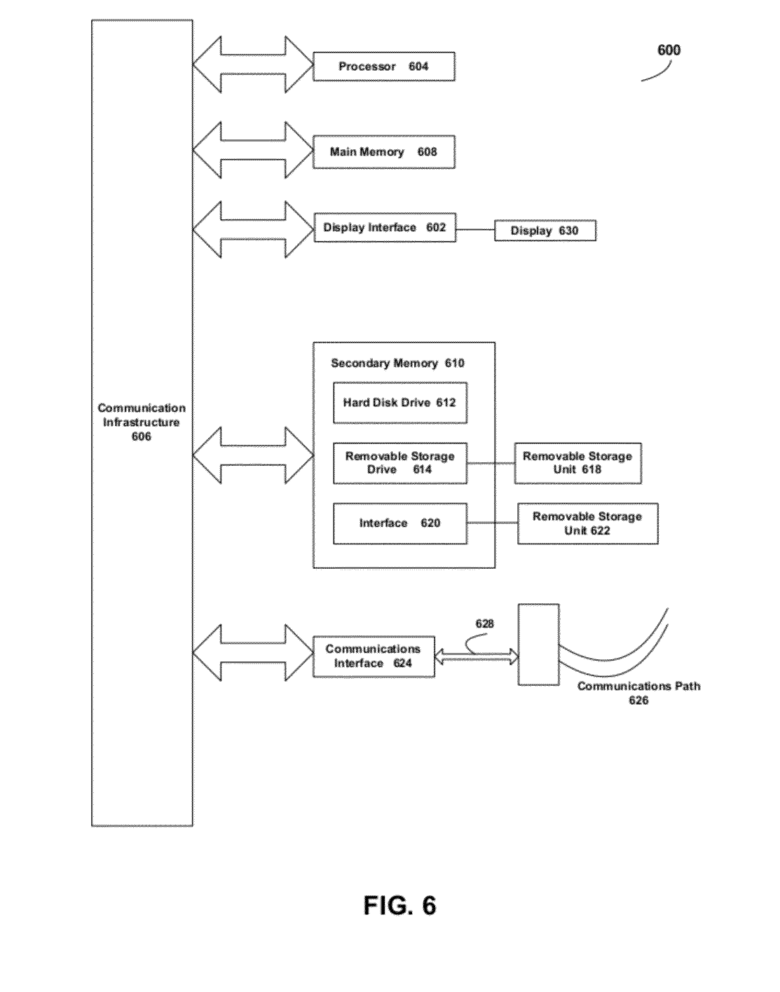

In fact, in one aspect, the invention is directed toward one or more computer systems capable of carrying out the functionality described herein. An example of a computer system 600 is shown in FIG. 6.

Computer system 600 includes one or more processors, such as processor 604. The processor 604 is connected to a communication infrastructure 606 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 600 can include a display interface 602 that forwards graphics, text, and other data from the communication infrastructure 606 (or from a frame buffer not shown) for display on the display unit 630.

Computer system 600 also includes a main memory 608, preferably random access memory (RAM), and may also include a secondary memory 610. The secondary memory 610 may include, for example, a hard disk drive 612 and/or a removable storage drive 614, representing a floppy disk drive, a magnetic tape drive, an optical disk drive, etc. The removable storage drive 614 reads from and/or writes to a removable storage unit 618 in a well known manner. Removable storage unit 618 represents a floppy disk, magnetic tape, optical disk, etc. which is read by and written to by removable storage drive 614. As will be appreciated, the removable storage unit 618 includes a computer usable storage medium having stored therein computer software and/or data.

In alternative aspects, secondary memory 610 may include other similar devices for allowing computer programs or other instructions to be loaded into computer system 600. Such devices may include, for example, a removable storage unit 622 and an interface 620. Examples of such may include a program cartridge and cartridge interface (such as that found in video game devices), a removable memory chip (such as an erasable programmable read only memory (EPROM), or programmable read only memory (PROM)) and associated socket, and other removable storage units 622 and interfaces 620, which allow software and data to be transferred from the removable storage unit 622 to computer system 600.

Computer system 600 may also include a communications interface 624. Communications interface 624 allows software and data to be transferred between computer system 600 and external devices. Examples of communications interface 624 may include a modem, a network interface (such as an Ethernet card), a communications port, a Personal Computer Memory Card International Association (PCMCIA) slot and card, etc. Software and data transferred via communications interface 624 are in the form of signals 628 which may be electronic, electromagnetic, optical or other signals capable of being received by communications interface 624. These signals 628 are provided to communications interface 624 via a communications path (e.g., channel) 626. This channel 626 carries signals 628 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 614, a hard disk installed in hard disk drive 612, and signals 628. These computer program products provide software to computer system 600. The invention is directed to such computer program products.

Computer programs (also referred to as computer control logic) are stored in main memory 608 and/or secondary memory 610. Computer programs may also be received via communications interface 624. Such computer programs, when executed, enable the computer system 600 to perform the features of the present invention, as discussed herein. In particular, the computer programs, when executed, enable the processor 604 to perform the features of the present invention. Accordingly, such computer programs represent controllers of the computer system 600.

In an aspect where the invention is implemented using software, the software may be stored in a computer program product and loaded into computer system 600 using removable storage drive 614, hard drive 612 or communications interface 624. The control logic (software), when executed by the processor 604, causes the processor 604 to perform the functions of the invention as described herein.

In another aspect, the invention is implemented primarily in hardware using, for example, hardware components such as application specific integrated circuits (ASICs). Implementation of the hardware state machine so as to perform the functions described herein will be apparent to persons skilled in the relevant art(s).

In yet another aspect, the invention is implemented using a combination of both hardware and software.

In general, computer-readable memory media applied in association with aspects of the invention described herein may include any memory medium capable of storing instructions executed by a programmable apparatus. Where applicable, method steps described herein may be embodied or executed as instructions stored on a computer-readable memory medium or memory media. These instructions may be software embodied in various programming languages such as C++, C, Java, PHP, and/or a variety of other kinds of software programming/scripting languages that may be applied to create instructions in accordance with aspects of the invention.

While various aspects of the present invention have been described above, it should be understood that they have been presented by way of example and not limitation. It will be apparent to persons skilled in the relevant art(s) that various changes in form and detail can be made therein without departing from the spirit and scope of the present invention. Thus, the present invention should not be limited by any of the above described exemplary aspects, but should be defined only in accordance with the following claims and their equivalents.

In addition, it should be understood that the figures in the attachments, which highlight the structure, methodology, functionality and advantages of the present invention, are presented for example purposes only. The present invention is sufficiently flexible and configurable, such that it may be implemented in ways other than that shown in the accompanying figures.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present invention in any way.

What is claimed is:

1. A method for facilitating the generation of a knowledge base that may be integrated into an automated e-health diagnosis system in order to provide real-time decision support, the method executing on at least one processor of a computing device, comprising the steps of:
(a) providing a graphical user interface (GUI), on the computing device, to an author, wherein such GUI allows said author to enter content related to at least one symptom and at least once associated diagnosis;
(b) storing, by a token authority located within the computing device, said content; and
(c) deploying said content, in the form of an XML file, to at least one local data store for use by the automated e-health diagnosis system.
